(19) United States
(12) Patent Application Publication
(10) Pub. No.: US 2009/0257821 A1
(43) Pub. Date: Oct. 15, 2009

(54) DEVICE FOR BRACED FRAME ASSEMBLY AND METHOD OF USING SAME

(75) Inventors: Avik Ghosh, Irvine, CA (US); George Lewis Richards, Los Alamitos, CA (US)

Correspondence Address: FOLEY AND LARDNER LLP;SUITE 500, 3000 K STREET NW, WASHINGTON, DC, 20007, US

(73) Assignee: BORM Products, LLC

(21) Appl. No.: 12/102,743

(22) Filed: Apr. 14, 2008

(51) Int. Cl. F16D 1/00

(52) U.S. Cl. 403/205; 403/408.1

(57) ABSTRACT

A device for braced frame assembly and method of using same in connecting brace members to a beam of a braced frame is presented. The braced frame connectors of the invention have a preferred application in cold formed steel frames in light-framed construction but can also be used effectively in braced frames of heavy-frame construction and can provide sufficient rigidity while adequately resisting lateral loads.

### FIELD OF THE INVENTION

The present invention generally relates to structural reinforcement devices in the construction industry and more particularly to braced frames for walls.

### BACKGROUND OF THE INVENTION

Lateral forces created by wind pressure or by seismic activity create substantial lateral loads (e.g., shear forces) in a building and have the potential to collapse a building not properly constructed to resist these lateral loads. Consequently, buildings are designed with “bracing” elements that can provide the necessary capacity for a building to withstand substantial lateral forces. However, there is substantial need for improvement in bracing elements, particularly with respect to resisting seismic loads.

The present invention provides a structural component, namely, a device for braced frame assembly that couples brace elements in a braced frame to a beam therein.

### SUMMARY OF THE INVENTION

In one embodiment of the present invention, a device for coupling a brace element to a beam in a brace frame is provided, the device comprising a solid plate having a trapezoidal shape and a “deformation” therethrough or thereon. The device may comprise steel, light-gauge metal, aluminum or a composite material and further comprise a fastening means for fastening the brace elements to the connector. The deformation may comprise an indentation or extrusion, but is preferably a hole through the connector which can be circular in shape, having a diameter approximately equal to 30% of the height of the plate. The circle may have a diameter between ½ an inch to about 6 inches, preferably between about 3 inches to about 5 inches, and most preferably a diameter of about 4 inches. The width of the connector may be calculated as about 1/30^{th} of the width of the brace element(s). Accordingly, the connector may have a length between about 6 inches to about 18 inches, preferably between about 9 inches to about 15 inches, and most preferably a length of about 12 inches.

In another embodiment of the invention, a braced frame assembly is provided comprising: (a) two columns each having a bottom end and a top end and perpendicularly affixed to a beam positioned atop the two columns; and (b) two brace elements spanning from a bottom portion of the columns to the beam, wherein the two brace elements are coupled to the beam via a connector comprising a solid plate having a trapezoidal shape and an opening therethrough. The connector may further comprise a fastening means for fastening the brace elements to the connector. The fastening means can be selected from the group consisting of welds, nails, screws, pins, bolts, rivets or a combination thereof. The brace elements comprise structural steel, cold formed steel, light-gauge metal, aluminum, wood, engineered wood, polymers, or composite material.

In the braced frame assembly, the brace elements are coupled to the beam at an angle of greater than about 45° with the beam, preferably an angle of less than about 85° with the beam, and most preferably at an angle of about 80° with the beam. As well, the brace elements can be coupled to the beam via a connector positioned at the midpoint between the two columns in a braced frame assembly.

In yet another embodiment of the present invention, a system for reducing horizontal (shear) and vertical (uplift) forces between an upper portion and a foundation of a building is provided comprising: a wall comprising two vertical columns each having a bottom end and a top end, and a horizontal beam spanning the top ends of the two vertical columns; and a bracing assembly that fits within a space defined by the two vertical columns and the horizontal beam, wherein the bracing assembly comprises: an anchor that anchors the bracing assembly to a floor or foundation of the building; a brace connector that couples the bracing assembly to the beam of the surrounding wall structure and wherein the brace connector comprises a solid plate having a trapezoidal shape and a deformation therethrough; a first brace member having an upper and a lower end spanning the anchor and the brace connector wherein the upper end of the first brace member is attached to the brace connector and wherein the lower end of the first brace member is attached to the anchor assembly of one column or base element; and a second brace member having an upper and a lower end spanning the anchor and the brace connector wherein the upper end of the second brace member is attached to the brace connector and wherein the lower end of the second brace member is attached to the anchor assembly of the other column or base element, such that when a lateral shear force is exerted on the beam, one of the first or second brace members is in compression and the other one of the first and second members is in tension.

In further yet another embodiment of the invention, a method of bracing one or more brace elements to a beam in a braced frame is provided comprising coupling the one or more brace elements to the beam via a device comprising a solid plate having a trapezoidal shape and an opening therethrough, wherein the device absorbs strain energy applied to the braced frame primarily through shear yielding, but can also experience flexural yielding, buckling, tension yielding, or combinations thereof.

The invention also provides a method of reinforcing a building structure comprised of a wall having a plurality of vertical column members and at least one horizontal beam member spanning at least two of the plurality of vertical column members, the method comprising: (a) mechanically coupling a lateral load resisting assembly to the upper horizontal beam element of the wall; (b) mechanically coupling the lateral load resisting assembly to the foundation such that the lateral load resisting assembly transmits lateral shear forces on the upper horizontal beam element of the wall to the foundation so as to reduce the tendency of the upper portions of the vertical framing members to move laterally when exposed to lateral loads; and (c) mechanically interposing an energy absorption device within the lateral load resisting assembly such that the energy associated with the lateral forces on the upper horizontal beam element of the wall is absorbed by the energy absorption device primarily through shear, but also potentially through flexure, tension, or buckling yielding modes or combinations thereof.

There has thus been outlined, rather broadly, certain embodiments of the invention in order that the detailed description thereof may be better understood, and in order that the present contribution to the art may be better appreciated. There are, of course, additional embodiments of the invention that may be described below and which may form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art may appreciate that the conception upon which this disclosure is based may readily be utilized as a basis for the designing of other structures, methods and systems for carrying out the present invention. It is important, therefore, that the claims be regarded as including such equivalent constructions.

### BRIEF DESCRIPTION OF THE DRAWINGS

FIG. 1 is an illustration of a braced frame comprising a connector of the present invention.

FIG. 2 is an isometric view of one embodiment of a connector in accordance with the present invention.

FIG. 3 provides non-limiting examples of various shapes that the inventive connector may have.

FIG. 4 provides a non-limiting example of how the deformation can also be an imprint on the inventive connector or an extrusion of the inventive connector

FIG. 5 provides non-limiting examples of various shapes that the deformation within the inventive connector may have.

FIG. 6 illustrates how the connector might deform in shape in response to rotational forces, or moments, shears, and axial loads that may be transferred between a beam and column.

FIG. 7 is an isometric view of another embodiment of a connector in accordance with the present invention.

FIG. 8 is an isometric view of yet another embodiment of a connector in accordance with the present invention.

FIG. 9 is an isometric view of still yet another embodiment of a connector in accordance with the present invention.

FIG. 10 is an isometric view of an embodiment of a connector in accordance with the present invention comprising a hollow interior.

FIG. 11 provides non-limiting examples of the use of a single brace element with the inventive connector.

FIG. 12 also provides non-limiting examples of locations where the inventive connector may be positioned within a braced framed unit.

FIG. 13 is a non-limiting example of the inventive connector as may be applied in the elevation of a multi-story light-frame structure.

FIG. 14 is a non-limiting example of the inventive connector as may be applied in the elevation of a single-story light-frame structure.

FIG. 15 is a non-limiting example of the inventive connector as it may be applied in the elevation of a multistory, high rise building.

### DETAILED DESCRIPTION OF THE INVENTION

Reference will now be made to the drawings wherein like numerals refer to like parts throughout.

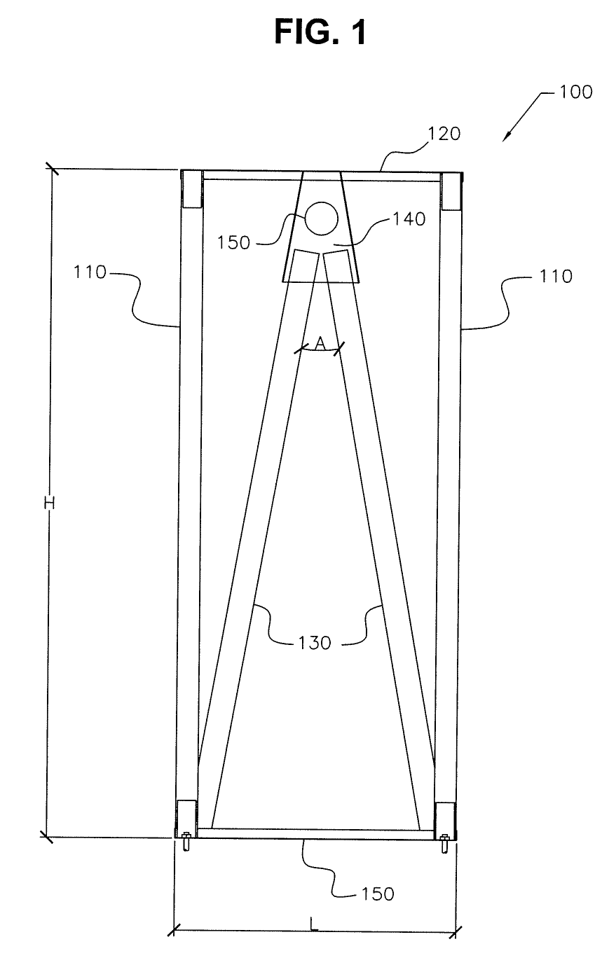

The invention provides a hardware device for application in braced frames, most commonly employed in the construction of low-rise residential and/or commercial building construction, but can also be used in high-rise construction. See, e.g., FIG. 1. A braced frame 100 (also referred to as a braced frame “unit” herein) is a wall of a building structure or portion thereof comprising two vertical column elements 110 affixed to a base element 150 and spanned by a beam element 120, typically positioned and affixed atop the two column elements 110. To “brace” the wall against lateral forces, one or more “brace” elements 130 can be incorporated into the frame, in which the brace element generally spans from an intersection at or near the lower end of a column element and a base element 150 to the beam element 120. The invention concerns a device 140 (also referred to herein as “connector”) that couples one or more brace elements to the beam.

The invention has been described herein, in some part, with application to braced frames comprising light gauge steel (e.g., cold-formed steel) beams and columns solely in the interest of clarity. That is, while the inventive device can be used in the context of cold formed steel braced frames, it should be appreciated that the invention may be applied alone or in conjunction with connections employed in braced frames of any structural material, including, but not limited to, structural steel, wood, concrete, polymers, and combinations thereof.

Also in the interest of clarity, it should be appreciated that not all forms and embodiments of devices of the present invention have been illustrated. Actual dimensions of the inventive device per se and accompanying braced frame may be expected to change from one application to the next. For example, a braced frame as shown in FIG. 1 can have an overall height of 108 inches, an overall length of 45 inches, and an overall width of 3.5 inches.

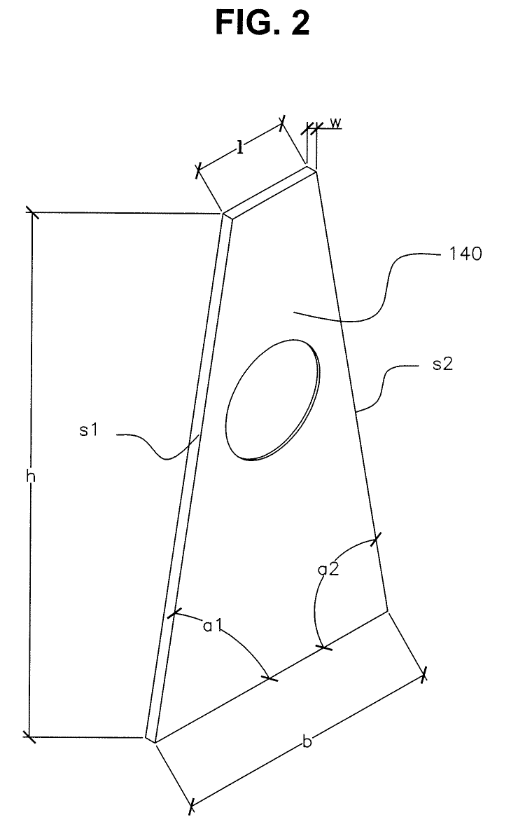

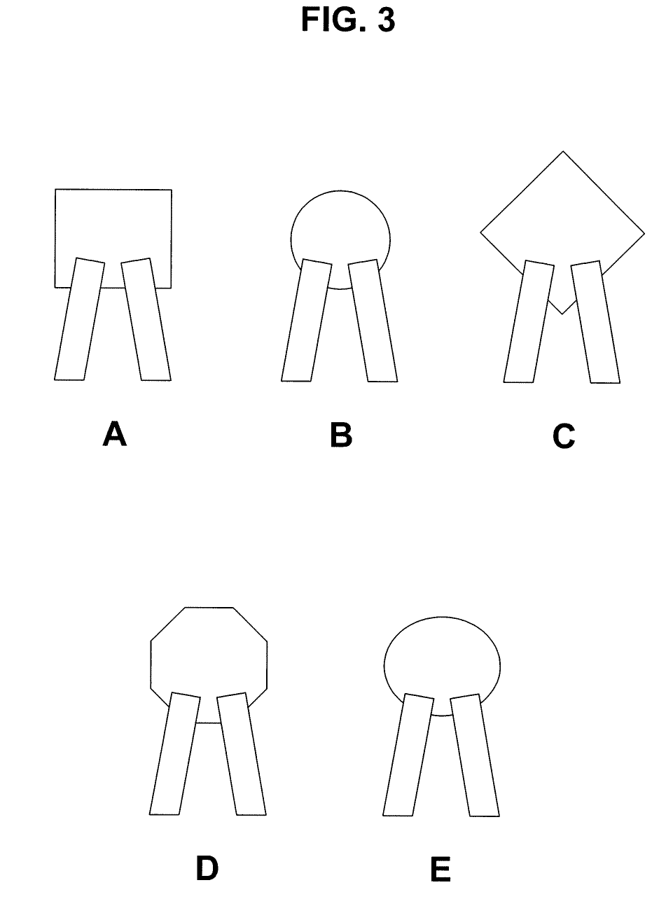

FIG. 2 depicts a connector 140 in accordance with one embodiment of the present invention. The connector 140 shown is trapezoidal in shape, more specifically an isosceles trapezoid. The trapezoidal shape is not a limiting feature of the invention as other shapes (e.g., square, rectangle) are contemplated. See, e.g., FIGS. 3A-E. However, the trapezoidal shape is preferable because it reduces undesired stresses at the connector 140 to beam connection, such as those that occur when the connector plate experiences rotation or twisting, caused by dimensional eccentricities due to manufacturing tolerances and errors at the brace to connector 140 connection. In the embodiment shown in FIG. 2, the connector 140 has a base of length b, height h, width w, and “top” of length 1. As with any isosceles trapezoid, b and I are substantially parallel, sides s₁ and s₂ are substantially of equal length, and the base angles a₁ and a₂ are substantially congruent. The term “substantially” or “about” are used interchangeably herein in consideration of nominal errors (typically, ±5%) or limits in measurement inherent in the art.

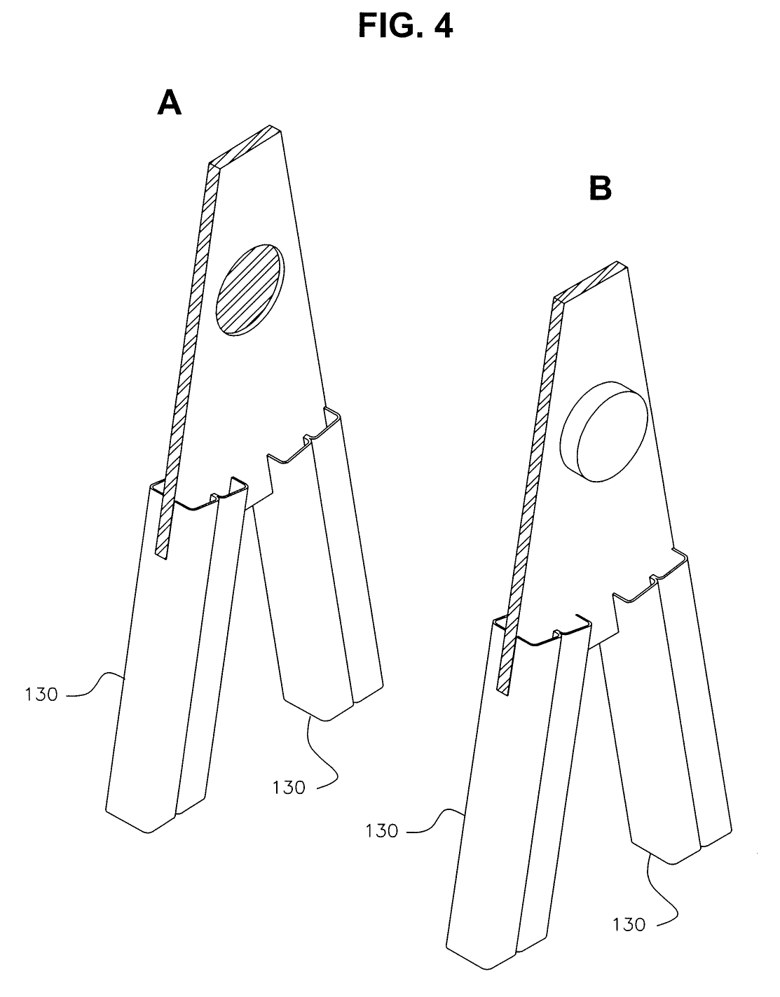

Connectors of the present invention also comprise a “deformation” (i.e., an “hole” or “opening” as shown in FIG. 2, an “indentation” as shown in FIG. 4A, or an “extrusion” as shown in FIG. 4B) that traverses width w through the connector. For holes, the deformation traverses width w from one face to the other face. For indentations, the deformation traverses width w for at least, 25%, preferably 50%, more preferably 75%, and most preferably 95% of width w.

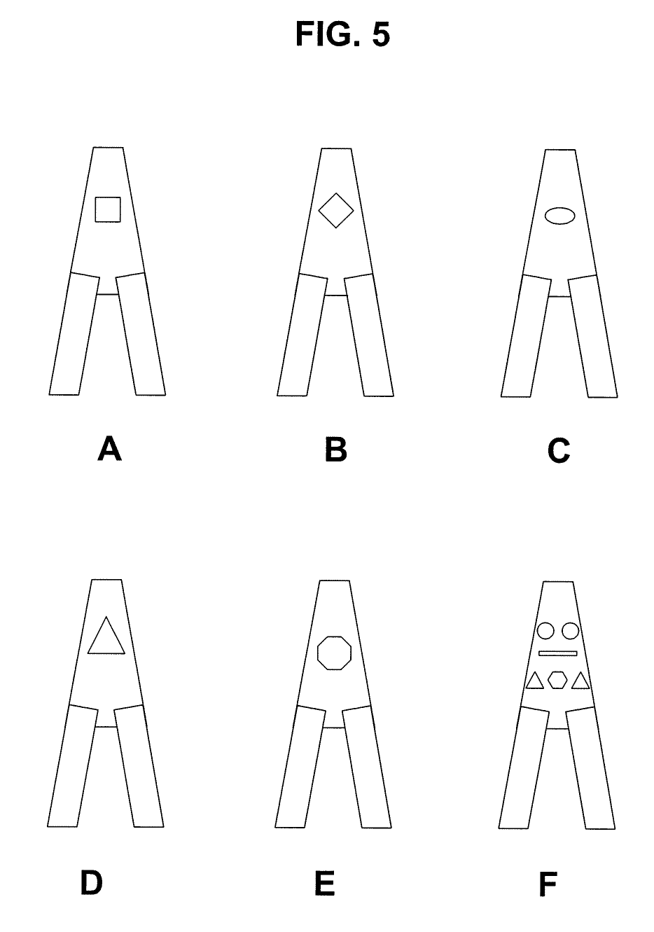

For extrusions, the deformation either protrudes out from a single face or both faces of connector 140 resulting in a width greater than width w. The deformation in the connector 140 is circular in shape, which is preferred for ease in manufacturing, e.g., by “punching.” However, as shown in FIGS. 5A-F, other shapes (e.g., oval, square, etc.) and combinations thereof are contemplated within the scope of the invention. Furthermore, a deformation that is a hole is envisioned as the preferred type of deformation for the connector.

The present inventors have discovered that inclusion of a hole dramatically improves the performance of the connector and ultimately of the entire frame unit. In fact, it has been discovered that the diameter d of the circle can govern the strength of the braced frame as an entire unit such that the larger the hole becomes the better the energy absorbing capability of the entire fame becomes. The diameter d is typically about ½ inch to about 12 inches, preferably about 3 inches to about 9 inches, and more preferably 5 inches to about 6 inches, for most embodiments in use for low rise structures today.

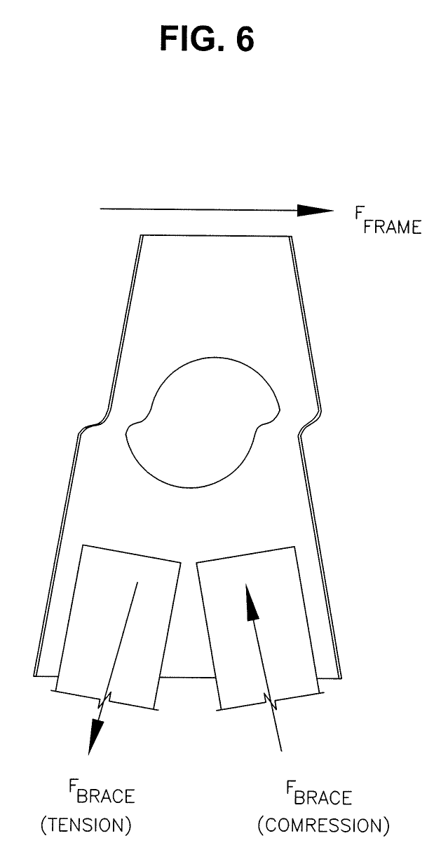

Without being held to or bound by theory, it is currently believed that the deformation allows a more ductile mode of yielding to occur than possible through the features of braced frame connections currently available. As shown in FIG. 6, the inventive connector serves as an energy absorption device within a lateral load resisting assembly such that the energy associated with any lateral force(s) F on a beam element in a frame within a wall is absorbed by the inventive connector primarily through shear, but also potentially through flexure, tension, or buckling yielding or combinations thereof. The inventive connector can provide a significant performance improvement over current braced frames in the industry by allowing a shear yielding mechanism within the connector to precede other less desirable yielding or failure mechanisms in the supporting members of the braced frame unit.

It is believed that the current invention is able to incorporate the advantages while eliminating or limiting the disadvantages of two common types of braced frames in current standard practice, namely, the Special Concentric Braced Frames (SCBF) and Eccentric Braced Frame (EBF). Indeed, the mode of yielding in SCBF, though ductile, is not as effective as the yielding caused by an EBF, which promotes shear yielding (and sometimes flexural yielding) to occur within a portion of the beam. However, the mode of yielding in EBFs requires certain requirements which can be economically disadvantageous, especially to the light frame construction industry, such as lateral bracing (out-of-plane restraint) of the beam element. The inventive connector allows a braced frame comprising same to combine the yielding properties of a SCBF and the superior performance of the EBF, while eliminating the latter's requirements for bracing the beam.

The height h of the connector is determined by satisfying the geometry resulting from the combination of the required distances for the brace to connector 140 connection, the angle of the brace, and the clearance distance required between the braces and/or the brace and the beam or column elements. For example, for a braced frame that is 109 inches tall, 45 inches wide, and that has two 3.5 inch by 3.25 inch braces with high strength steel, h is generally around 18 inches in order to ensure proper clear distance between braces and to ensure enough weld length is provided for brace element 130 to connector 140.

Just as in the determination for h, the length of base b is similarly determined. In other words, b is generally determined by satisfying the geometry resulting from the combination of the required distances for brace 130 to connector 140 connection, the angle of the brace, and the clearance distance required between the braces as well as requirements for tolerances in manufacturing. For example, for a braced frame that is 109 inches tall, 45 inches wide, and that has two 3.5 inch by 3.25 inch braces with high strength steel, b is generally around 12 inches in order to ensure proper clear distance between braces and to ensure enough weld length is provided for brace 130 to connector 140.

Connector 140 is shown as a planar plate, having two faces and an opening 150 therethrough. The width w of the connector can be varied and, as with the other dimensions of the inventive connector, tailored by structural engineers using methods known in the art to meet the performance and/or design specifications of the braced frame. In most cases, smaller and lighter connectors are preferred. Hence, the stronger the material, the smaller and/or thinner the connector can be without compromising performance. In the case of cold formed steel connectors, for example, w can range from about 0.01 inches to about 2 inches, preferably about 0.02 inches to about 0.25 inches, and more preferably 0.033 inches to about 0.125 inches.

In a preferred embodiment of the invention, the connector 140 has the following dimensions:

| Dimension | Range (in.) | Preference (in.) |
|---|---|---|
| B | 5-24 | 12 |
| L | 2-24 | 5 |
| H | 9-36 | 18 |
| W | 0.01-2 | 0.102 |
| D | 2-12 | 6 |

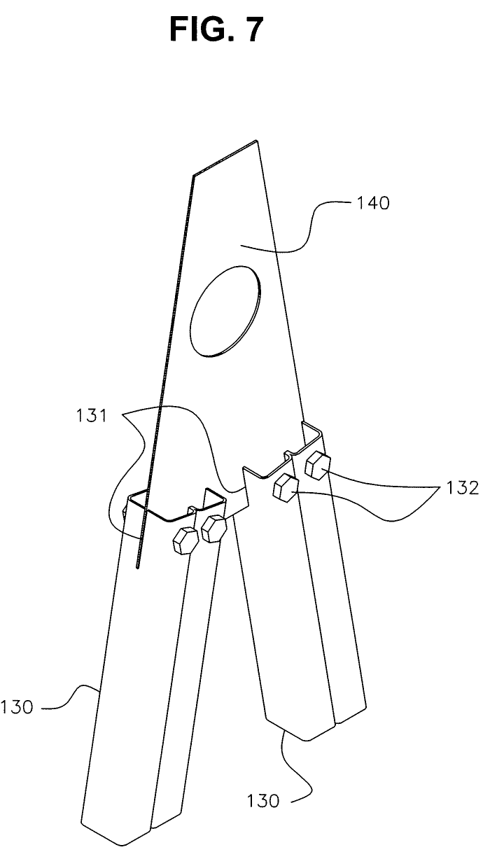

The connection of the inventive devices with brace element(s) does not require any fasteners, but may optionally include them. For example, FIG. 7 shows how brace elements 130 may be coupled to the connector via a slot 131 carved into the brace elements 130 as depicted. It is envisioned that installation of a brace element 130 to connector 140 through slot 131 ought to be welded to resist the forces transferred from the connector to the brace. It should be appreciated that the length of the slot 131 should be larger than the width w of brace element 130 to avoid a “shear-lag” phenomenon common in structural mechanics, in order for the connector to perform optimally.

While connector 140 need not require fasteners, it should be appreciated that fasteners may be used if forces are sufficiently low, fastener connection capacity is sufficiently high, or if redundancy in the connection is desired through a combination of fasteners and welds. Nails, screws, bolts, and other fasteners may comprise any material. Any material so used preferably transfers the associated forces and comfortably ensures that the beam/connector/brace element(s) assembly as a whole has sufficient ductility and overstrength when subject to cyclic loading. By way of example, FIG. 7 shows a connector 140 coupled to two brace elements 130 via slots 131. The brace elements 130 have been additionally fastened to the connector with through-bolts 132.

Preferably, a structural designer specifies standard construction material properties for all fasteners in accordance with the intended application. Fasteners and the numbers, sizes, spacing, and location thereof may also be similarly determined by a structural designer to address application specific needs. Similarly, adhesives can be used instead of fasteners or welds. Such determinations may be expected and methods for their calculation are generally known to one of ordinary skill in the art.

Connectors of the present invention can be connected to a beam by any means such as welding, fasteners, pressing, stamping, etc. Furthermore, the connector can be a portion of the beam that is folded or bent downward or molded out of beam element 120. Welding is the preferred means for connecting the connector to the beam and should have sufficient length, thickness, and strength to transfer the anticipated forces.

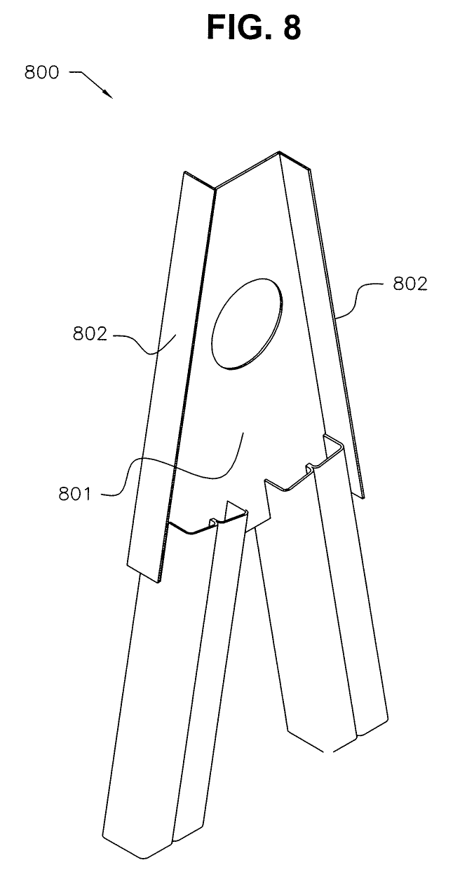

FIG. 8 depicts a connector 800 in another embodiment of the inventive connector. The connector 800 comprises a main plate 801 not unlike the plate of the connector 140. However, the connector 800 further comprises “stiffener” plates 802, which may constructed from a single plate or affixed (e.g., by welding) to the main plate 801. The stiffener plates are preferably at a 90° angle (i.e., perpendicular) to the main plate 802. In this embodiment, the brace members may be coupled with or without a slot. While in the latter case, fasteners must be used either through the flange plate and/or the main plate, in the former design, as mentioned above, fasteners are optional. The stiffener plates 802 may also be formed by way of folding or bending connector 140 at its ends, in which case no fastening mechanism would be required.

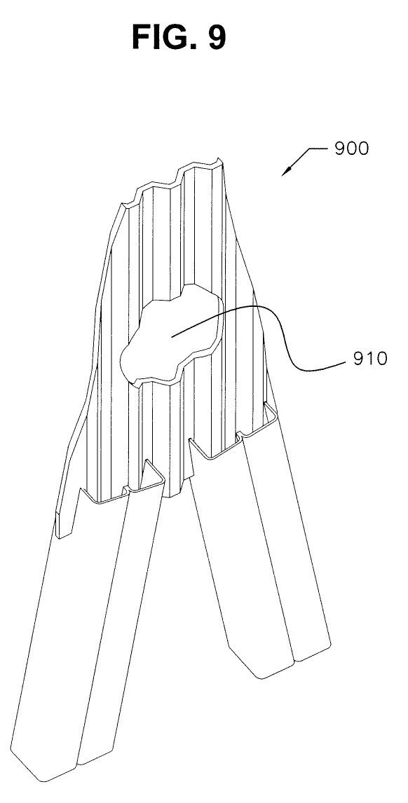

While the invention has been described with reference to planar connectors, the connectors may also be fashioned from non-planar surfaces, for example, corrugated surface. FIG. 9, for example, shows a connector 900 in accordance with the present invention fashioned from corrugated material and having a (circular) deformation 910 therein.

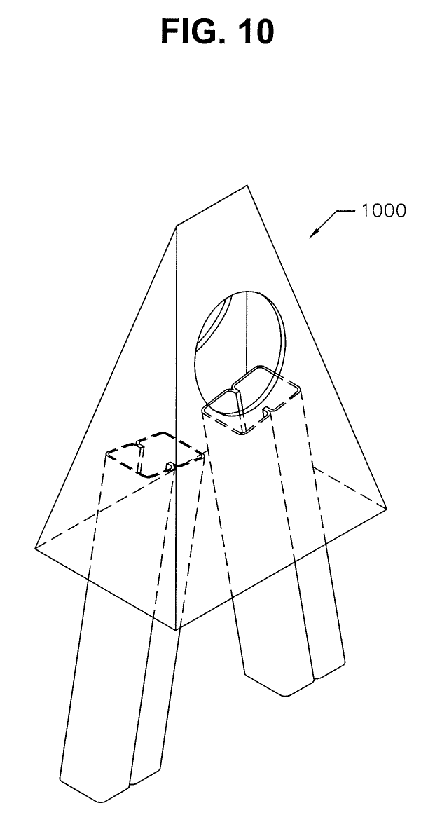

The connectors of the present invention need not have a solid interior. In fact, FIG. 10 shows a connector 1000 similar in design to that of connector 140 but for a hollow interior. “Hollow” connectors may have advantages in their manufacturing and application in the field. The connector 1000 is depicted with opening a rectangular opening (also referred to as “entry” or “sleeve”), it will be appreciated by one of ordinary skill in the art from the disclosure herein that other shapes and dimensions are also possible and to be expected. Such embodiments fall within the scope of the present invention. In a preferred embodiment, the opening need only be sized and shaped to accommodate a brace member of complimentary size and shape. More specifically, for constructability reasons, it is preferred that the inner dimensions of the connector's sleeves are only slightly larger than the outer dimensions of the brace element(s) it will house. This manner of construction allows tolerance for relatively smooth insertion of the brace elements into the connector 1000. As well, the inside face(s) of the openings may be lined with a liner.

The inventive connectors described herein provide a braced frame connector that can adequately resist lateral and vertical loads in accordance with most generally accepted design and building codes, e.g., the International Building Code and ASCE 7. While other connectors used for brace frames in the art may meet certain minimal Code standards, the connectors of the present invention have been found to be superior in providing energy dissipation and ductility, two important features desired for proper seismic performance.

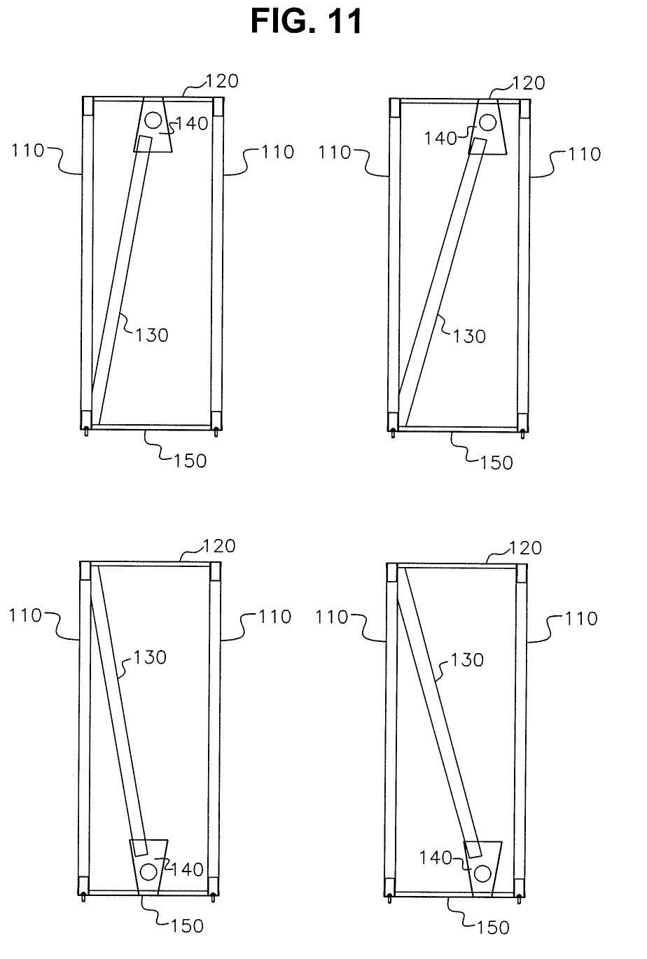

While the connectors of the present invention may be tailored for single brace frames as shown in FIG. 11, in a preferred embodiment, the connectors couple two brace elements to a beam. Referring now back to FIG. 1, the two brace elements 130 adjoining at the connector 140 form an angle A. This angle will depend on the length 160 and the height 170 of the braced frame unit 100, the height of the beam element 120, the height of the base element 150, the length of the column elements 110, and the length of the brace elements 130. In most embodiments, the angle A will be about 5 to about 45 degrees, but more preferably about 15 to about 25 degrees for embodiments in use for low rise structures today.

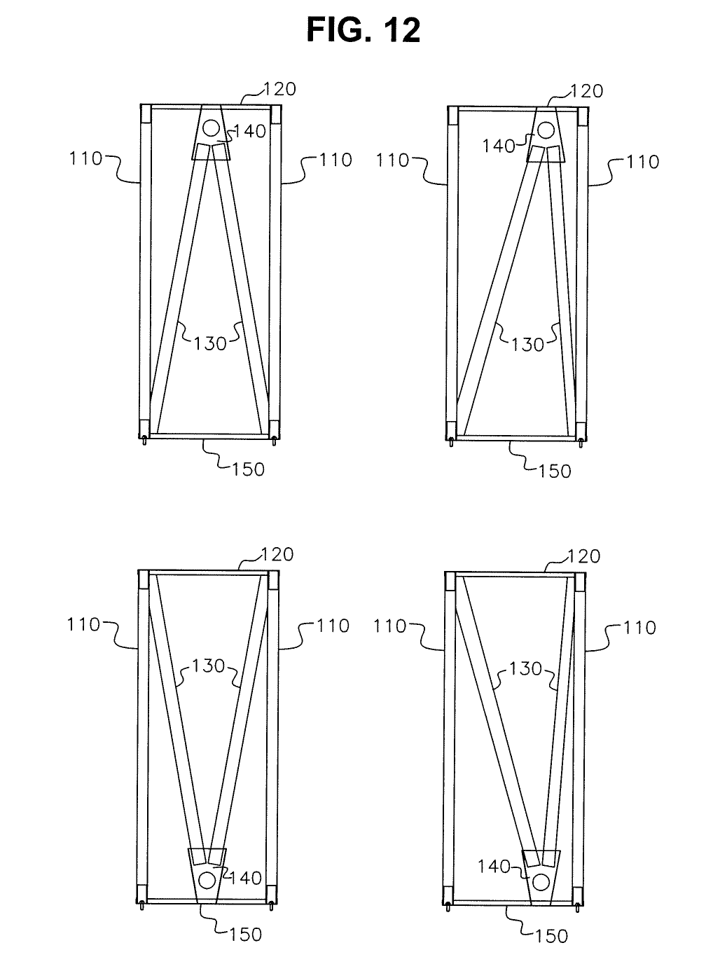

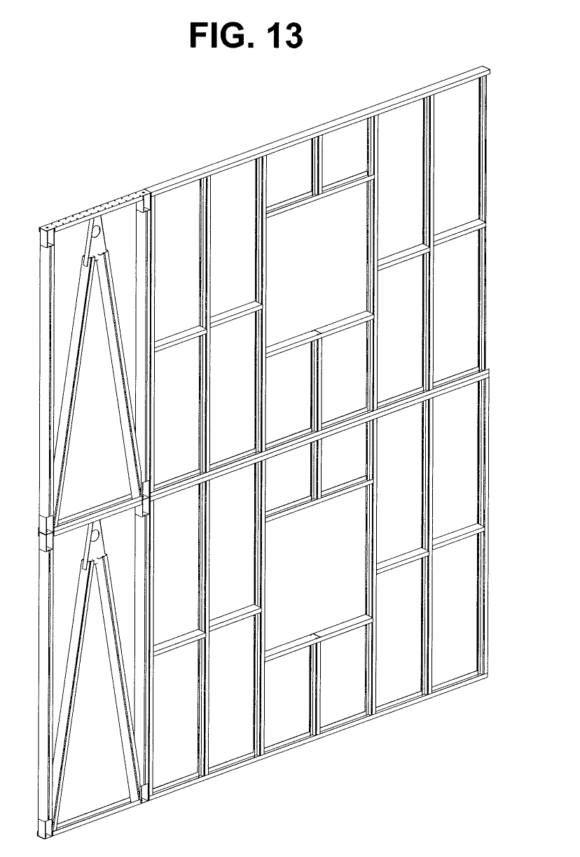

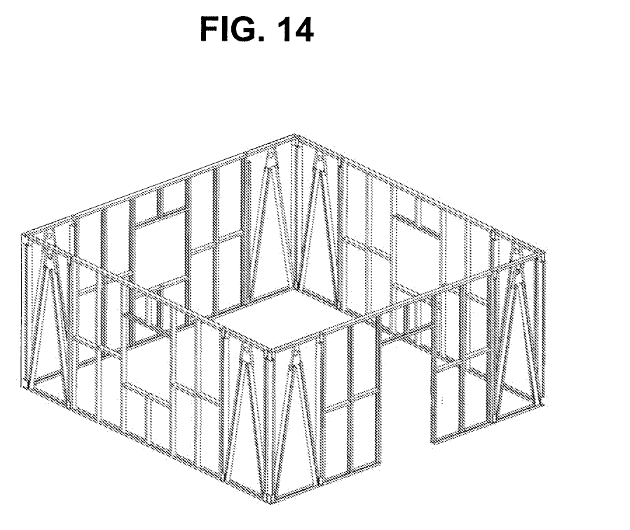

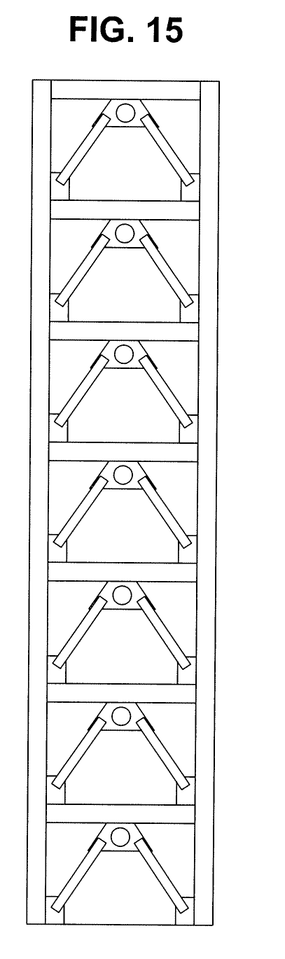

Braced frame assemblies form walls within light framed building structures and are often used in conjunction with, often adjacent to, a plurality of other braced frame assemblies or shear resisting wall elements. FIG. 12 shows an application of the connectors of the present invention at multiple locations in a given braced frame assembly within a given structure. Each brace element is shown as a diagonal element spanning from a bottom portion of a column to the midpoint of the beam in the braced frame assembly. The brace elements in the diagram are connected to each beam by means of an inventive connector. It should be noted that the connector may also be used for single and multi-story applications alike (see FIGS. 13-15).

The connectors of the instant invention may be constructed of various materials, but ductile materials such as structural steel or gauge metal are most preferable for cyclic loading events. For some embodiments discussed herein, the materials can either be rolled and bent or molded into the desired shape of the connector. Alternatively, the connector may be assembled together with discreet “plates” as shown in the figures. If steel or gauge metal is used, it is preferred that either the connector is bent and rolled into its desired shape or plates are welded together with standard welding practice. The connector can either be constructed in an assembly facility or on the construction site.

While the invention has been described in connection with specific embodiments thereof, it will be understood that it is capable of further modifications and this application is intended to cover any variations, uses, or alterations of the invention following. In general, the principles of the invention and including such departures from the present disclosure as come within known or customary practice within the art to which the invention pertains and as may be applied to the essential features hereinbefore set forth and as follows in the scope of the appended claims.

What is claimed is:

1. A device for coupling a brace element to a beam in a brace frame, the device comprising a solid plate having a trapezoidal shape and a deformation therethrough.

2. The device according to claim 1 comprising steel, light-gauge metal, aluminum or a composite material.

3. The device according to claim 1 in which the connector further comprises a fastening means for fastening the brace elements to the connector.

4. The device according to claim 1 in which the deformation through the connector is an opening and a circle in shape.

5. The device according to claim 4 in which the circle has a diameter between about 0.5 inches to about 10 inches.

6. The device according to claim 5 in which the circle has a diameter between about 2 inches to about 12 inches.

7. The device according to claim 6 in which the circle has a diameter equal to about 5.5 inches.

8. The device according to claim 1 in which the connector has a width of about 1/30^{th} of the width of brace element(s).

9. The device according to claim 8 in which the circle has a width between about 0.02 inches to about 0.25 inches.

10. The device according to claim 9 in which the circle has a width between about 0.033 inches to about 0.125 inches.

11. The device according to claim 10 in which the connector has a width of about 0.1012 inches.

12. A braced frame assembly comprising:
(a) two columns each having a bottom end and a top end and perpendicularly affixed to a beam positioned atop the two columns; and
(b) two brace elements spanning from a bottom portion of the columns to the beam,
wherein the two brace elements are coupled to the beam is via a connector comprising a solid plate having a trapezoidal shape and a deformation therethrough.

13. The braced frame assembly according to claim 12 in which the deformation is an opening and circle in shape.

14. The braced frame assembly according to claim 13 in which the connector further comprises a fastening means for fastening the brace elements to the connector.

15. The braced frame assembly according to claim 14 in which the fastening means is selected from the group consisting of a welds, nails, screws, pins, bolts, rivets, adhesives, or combinations thereof.

16. The braced frame assembly according to claim 15 in which the fastening means is a knife cut with welds fastening the brace elements to the connector.

17. The braced frame assembly according to claim 12 in which the brace elements comprise structural steel, cold formed steel, aluminum, wood, engineered wood, or polymers, or composite material.

18. The braced frame assembly according to claim 17 in which the brace elements comprise cold formed steel.

19. The braced frame assembly according to claim 12 in which the brace elements are coupled to the beam at an angle of greater than about 45° with the beam.

20. The braced frame assembly according to claim 19 in which the brace elements are coupled to the beam at an angle of less than about 85° with the beam.

21. The braced frame assembly according to claim 20 in which the brace elements are coupled to the beam at an angle of about 80° with the beam.

22. The braced frame assembly according to claim 13 in which the opening is a circle in shape.

23. The braced frame assembly according to claim 22 in which the circle has a diameter equal to 30% of the height of the connector.

24. The braced frame assembly according to claim 23 in which the circle has a diameter of about 5.5 inches.

25. The braced frame assembly according to claim 24 in which the connector has a width of 1/30^{th} of the width of the brace elements.

26. The braced frame assembly according to claim 25 in which the connector has a width of about 0.1017 inches.

27. The braced frame assembly according to claim 12 in which the brace elements are coupled to the beam via a connector positioned at the midpoint between the two columns.

28. A system for resisting lateral and vertical forces between an upper portion and a lower portion of a building, comprising:
a wall comprising two vertical columns each having a bottom end and a top end, and a horizontal beam spanning the top ends of the two vertical columns and a base element spanning the bottom ends of the two columns; and
a bracing assembly that fits within a space defined by the two vertical columns and the horizontal beam, wherein the bracing assembly comprises:
an anchorage system that anchors the bracing assembly to the base element;
a brace connector that couples the bracing assembly to the beam of the wall and wherein the brace connector comprises a solid plate having a trapezoidal shape and a deformation therethrough;
a first brace member having an upper and a lower end spanning the anchor and the brace connector wherein the upper end of the first brace member is attached to the brace connector and wherein the lower end of the first brace member is attached to the anchor assembly of one column; and
a second brace member having an upper and a lower end spanning the anchor and the brace connector wherein the upper end of the second brace member is attached to the brace connector and wherein the lower end of the second brace member is attached to the anchor assembly of the other column,
such that when a lateral shear force is exerted on the beam, one of the first or second brace members is in compression and the other one of the first and second members is in tension.

29. A method of connecting one or more brace elements to a beam in a braced frame via a device comprising coupling a solid plate having a trapezoidal shape and a deformation therethrough to a beam of a structure stabilizing frame, wherein the device absorbs the energy applied to the braced frame by yielding through shear, tension, flexure, buckling, or combinations thereof.
